(19) United States
(12) Patent Application Publication
(10) Pub. No.: US 2009/0067594 A1
(43) Pub. Date: Mar. 12, 2009

(54) Digital telephone systems

(76) Inventor: Mark Hillman, West Midlands (GB)

Correspondence Address: DAVIS & BUJOLD, P.L.L.C., 112 PLEASANT STREET, CONCORD, NH, 03301, US

(21) Appl. No.: 11/665,874

(22) PCT Filed: Oct. 19, 2005
(86) PCT No.: PCT/GB05/04025

§ 371 Date: Apr. 20, 2007

(30) Foreign Application Priority Data
Oct. 20, 2004 (GB) 0423281.5

(51) Int. Cl. H04M 11/00

(52) U.S. Cl. 379/93.17

(57) ABSTRACT

A digital telephone system provides visual displays of live events to a digital telephone device. An animation script is generated according to real time actions which make up the live event. The digital telephone system transmits the animation script to the digital telephone which is preloaded with a smart client application. The smart client application receives the animation script, for example in the form of a SMS or MMS message, and the animation script controls the smart client application such that objects on a visual display are moved in order to simulate the live event.

The present invention relates to digital telephone systems and in particular to the broadcasting of live events to digital telephones, with visual display means.

Currently reports of real time events may be transmitted to digital telephones in text format to give a real time commentary on the event. With the advent of 3 G telephones, with full Internet capabilities, it should be possible to broadcast an event, real time, in video format. Video download of real time events is even possible with current 2.5 G MMS or EMS technologies using WAP links. However, with current technologies the video signal must be compressed and is consequently of inferior quality, is difficult to deliver, and is expensive, costing about £1.50 for 12 seconds. Moreover, a typical mobile phone is only capable of storing about 10 such animations.

The present invention provides a system of providing a real time visual display of an event on a 2 G or 2.5 G mobile telephone, using text messages provided via SMS (Short Message Service) or MMS (Multimedia Message Service) link.

According to one aspect of the present invention, a digital telephone system for providing visual displays of live events comprises:

means for providing a data feed in text format of real time actions which make up a live event;

means for converting the data feed into an animation script which controls the movement of objects in a simulation of the live event;

means for transmitting the animation script as a text message to a digital telephone device; and

a digital telephone device, the digital telephone device having a visual display and being programmed with a smart client application, the smart client application including fixed background data relating to the live event, the smart client application being controlled by the animation script so that the objects are moved to simulate the actions of the live event.

With the digital telephone system disclosed above, the text messages by which the animation script is sent to the digital telephone device, for example mobile telephone, may be sent by SMS or MMS, a single text message containing about 12 seconds of action, costing about 25 p. Moreover, a typical 2 G or 2.5 G telephone device may store up to 60 text messages, permitting replays of live events at the digital telephone device.

According to a preferred embodiment of the invention, the animation script, which is transmitted by the digital telephone system, comprises a plurality of key frames, which define the positions and actions of the players and the position of the ball, at discrete moments during the event. The smart application, which is loaded onto the digital telephone, interpolates between the key frames, to generate intermediate frames. Typically the visual display on the digital telephone will run at 10 to 14 frames per second. An event lasting about 30 seconds (300 to 420 frames) may typically be based on four key frames.

Preferably, the smart client application is downloaded to the digital telephone over the telephone system. The smart client application may cover a single event, for example a football match, or a series of events, for example all football matches or all football matches in which a specified team participates. The system may be used for other sporting events or for other events, in which fixed background data relating, for example, to the venue or the participants, can be pre-loaded into the digital telephone as part of the smart client application. The smart client application also includes software for controlling movement of the participants on the visual display, in accordance with the animation script, which is received in real time by the digital telephone.

The invention is now described, by way of example only, with reference to the accompanying drawings in which:

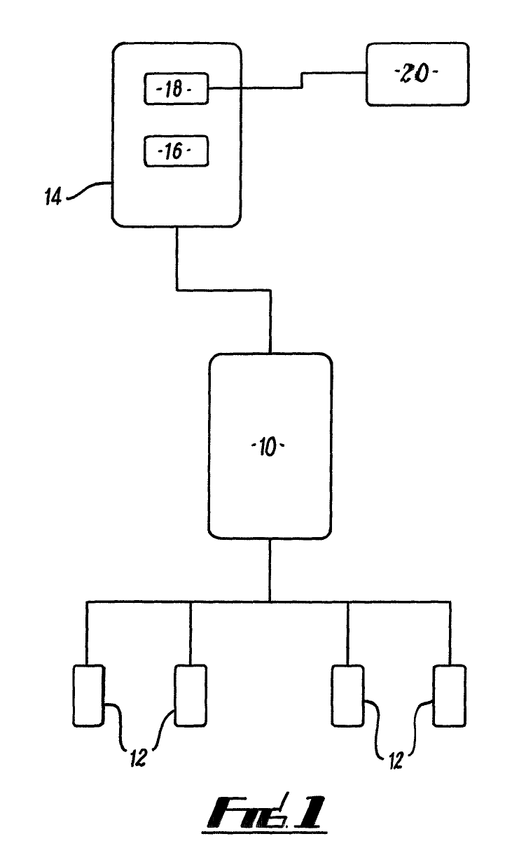

FIG. 1 is a schematic illustration of a digital mobile telephone system in accordance with the present invention;

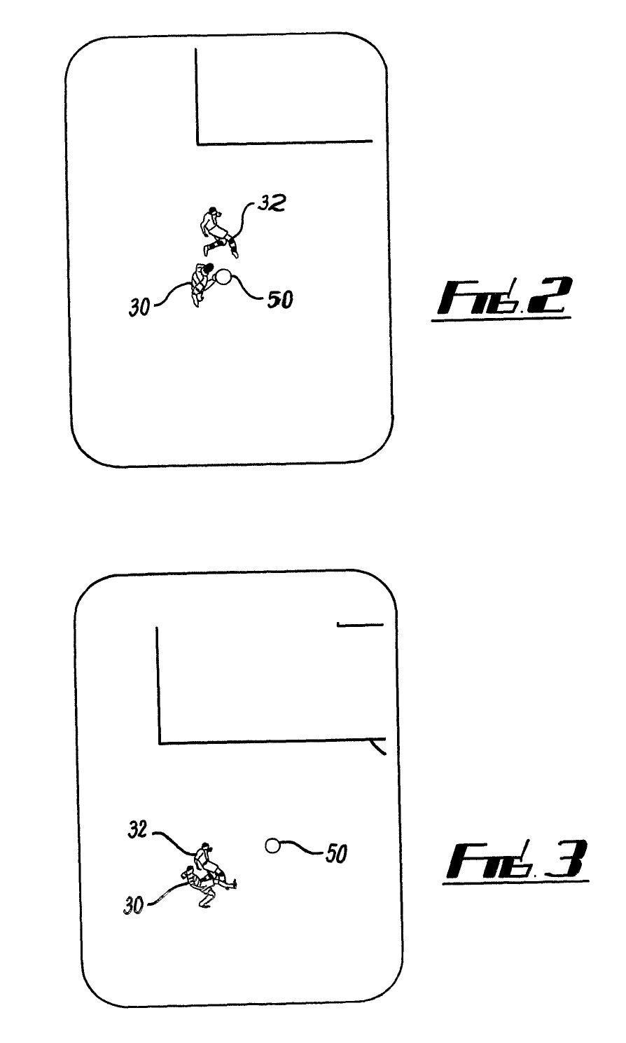

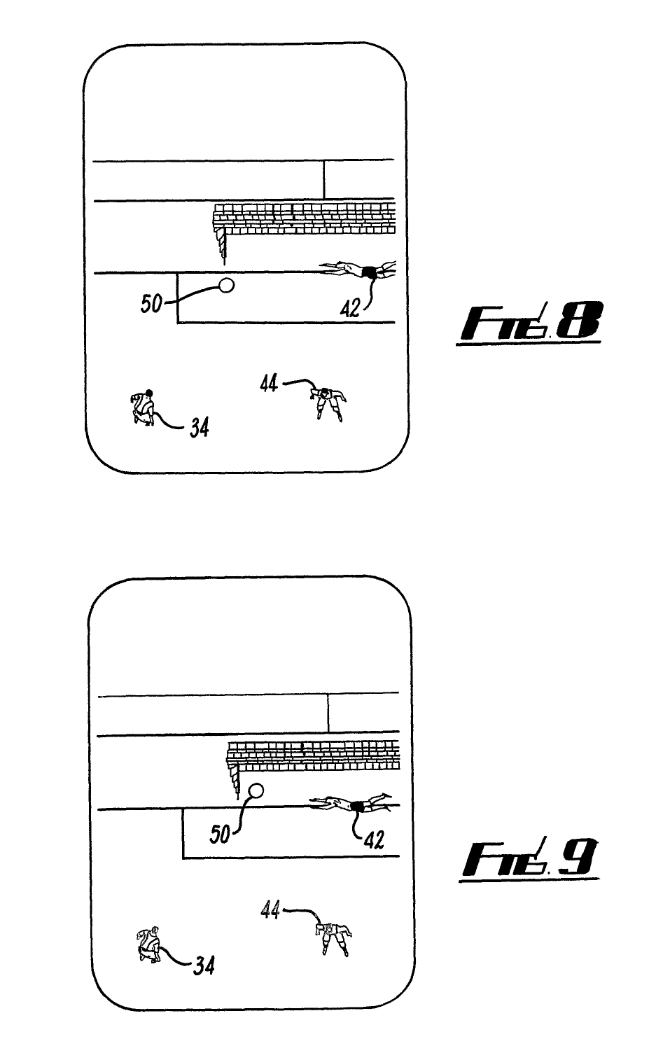

FIGS. 2 to 12 show frames of a visual display provided by a digital telephone system in accordance with the present invention, of action from a football match; and

FIG. 13 shows an event editor screen used to provide key-frame data for the visual display.

FIG. 1 illustrates a digital mobile telephone system by which “alerts”, that is simulations of actions that make up an event, may be sent to individual mobile telephone devices 12. The system comprises a SMS (Short Message Service)/MMS (Multimedia Message Service) Centre 10, which transmits messages to and receives messages from the mobile telephone devices 12. While in FIG. 1 the various components of the system are interconnected by lines, it will be appreciated that in a mobile system, the SMS/MMS Centre 10, will be connected to the mobile telephone devices 12 by radio links.

A dedicated download server 14 is also connected to the SMS/MMS Centre 10 via an internet connection. The download server includes a subscriber database 16 in which details of subscribers, e.g. mobile telephone number, make and model of phone and billing details are stored.

The download server 14 also includes a replay module 18 which is connected via the internet to a source 20 of a data feed 20, providing data for text reporting of the event. The replay module 18 converts the data feed into an animation script which is sent via the SMS/MMS Centre 10 to the mobile devices 12 of subscribers to the system.

To subscribe to digital telephone system described above, a purchaser may text the word “ALERT” or some such similar word to a specified shortcode number corresponding to the download server 14. The subscriber's number, make and model are then logged into the subscriber database 14 and a smart client application is then sent by the SMS/MMS Centre to the subscribers mobile telephone device 12. Animation scripts, compiled as described in detail below, will then be sent to the subscriber and billed to the subscriber. The subscription may be cancelled by texting the word “CANCEL” or some such similar word to the specified shortcode number. The subscribers number, make and model will then be cross referred in the subscriber database 14, so that “Alerts” will no longer be sent to that subscriber.

The smart client application may relate to a particular event, for example a particular football match, or to a series of events, for example all football matches involving one particular team.

FIGS. 2 to 12 show frames from a typical display provided by the digital mobile telephone system described above, simulating an event in a football match between Chelsea and Leicester. The players are represented by graphical elements (sprites) 30 to 44 and the ball by sprite 50.

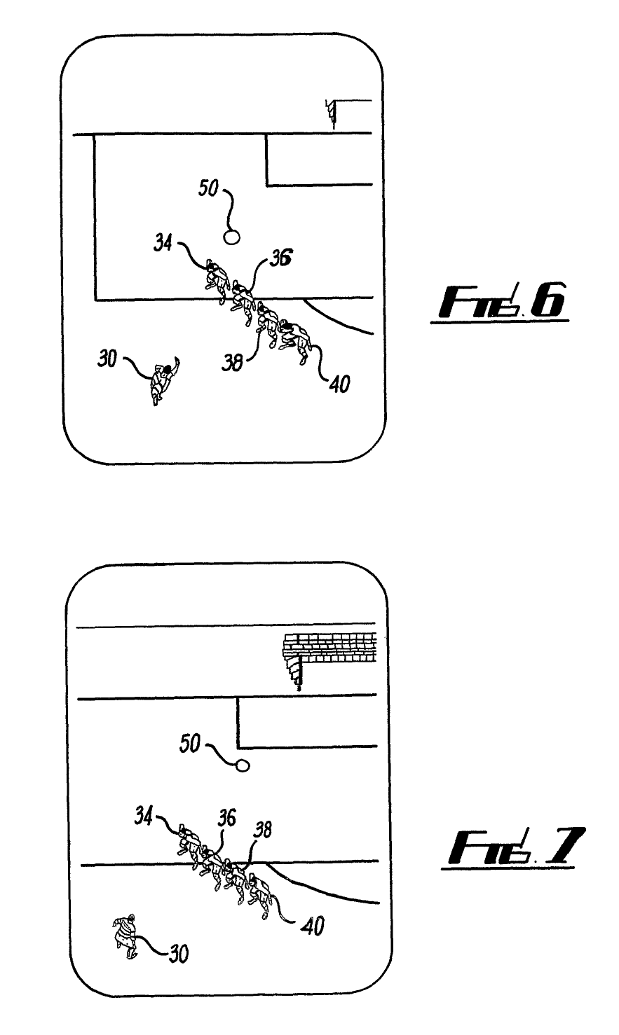

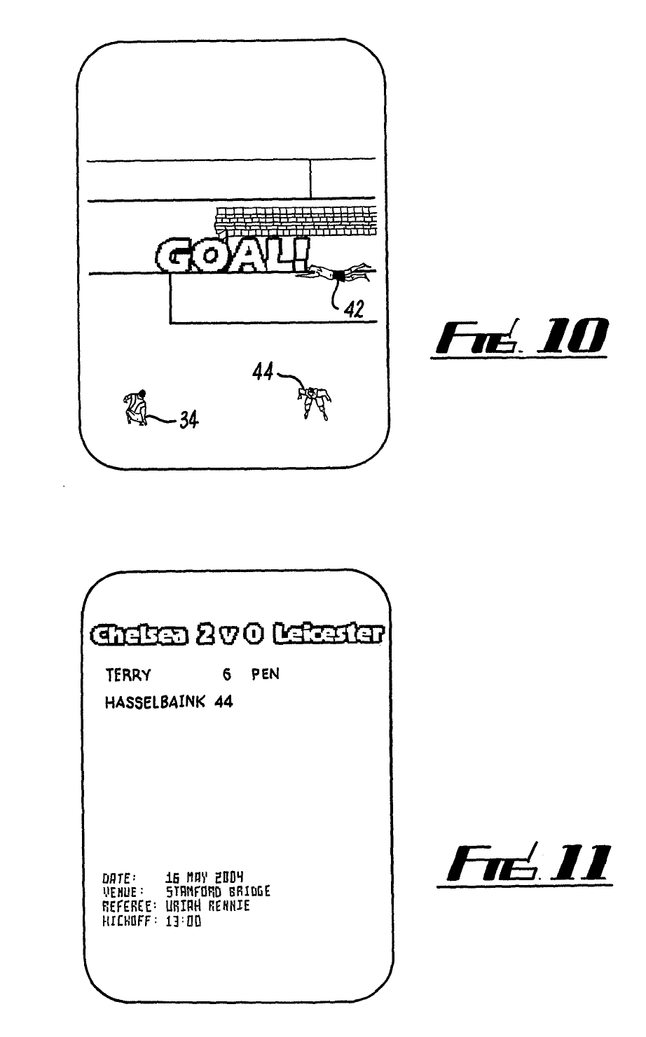

The event simulated is a foul, which was committed 24 minutes and 45 seconds into the game, by Billy McKinley of Leicester, represented by sprite 32 in FIGS. 2 and 3, on Jimmy Floyd Hasselbaink of Chelsea, represented by sprite 30. A free kick was awarded, on the left side of the field, about 25 yards from goal, see FIG. 5. From the free kick, Jimmy Floyd Hasselbaink 30 scored a goal in the bottom left of the goal, see FIG. 9.

Various news associations provide XML feeds for providing text reporting of football matches and other sporting events. A typical XML feed, reporting the event described above, is given below:

```
<?xml version=“1.0” standalone=“no” ?>
- <MatchLive id=“2315037”
      xmlns=“urn:x-pa-press-net:sport-matchlive-soccer”
      xmlns:xsi=“http://www.w3.org/2001/XMLSchema-instance”
      xsi:schemaLocation=“urn:x-pa-press-net:sport-matchlive-soccer
      matchlive-
```

| | |
|---|---|
| soccer.xsd”> | (A) |

| | |
|---|---|
| - <Event id=“1” correction=“No”> | (B) |

```
      - <Foul id=“4220207” correction=“No” normalTime=“42:45”
          addedTime=“0:00” rating=“0” outcome=“Free Kick”>
        - <FoulOn>
            - <Player id=“32973”>
              <Name firstName=“Jimmy Floyd”
                lastName=“Hasselbaink” />
            </Player>
            <Team id=“4” name=“Chelsea”>Chelsea</Team>
          </FoulOn>
        - <FoulBy>
          - <Player id=“122”>
              <Name firstName=“Billy” lastName=“McKinlay” />
            </Player>
            <Team id=“29”>Leicester</Team>
          </FoulBy>
```

| | |
|---|---|
| </Foul> | (C) |

```
    - <FreeKick id=“4220208” correction=“No” normalTime=“42:48”
        addedTime=“0:00” how=“Right Foot” whereFrom=“Left
        Channel”
        outcome=“Shot”>
      - <Player id=“32973”>
          <Name firstName=“Jimmy Floyd”
              lastName=“Hasselbaink” />
        </Player>
        <Team id=“4” name=“Chelsea”>Chelsea</Team>
```

| | |
|---|---|
| </FreeKick> | (D) |

```
    - <Shot id=“4220209” correction=“No” normalTime=“43:26”
        addedTime=“0:00” how=“Right Foot” whereFrom=“Left
        Channel”
        distance=“25” outcome=“Goal” type=“Normal” rating=“2”
        onTarget=“Yes”>
      - <Player id=“32973”>
          <Name firstName=“Jimmy Floyd”
            lastName=“Hasselbaink” />
        </Player>
        <Team id=“4” name=“Chelsea”>Chelsea</Team>
```

| | |
|---|---|
| </Shot> | (E) |

```
    - <Goal id=“4220210” correction=“No” normalTime=“43:26”
        addedTime=“0:00” how=“Right Foot” whereFrom=“Left
        Channel”
        whereTo=“Left Low” distance=“25” ownGoal=“No”
        rating=“2”>
      - <Player id=“32973”>
          <Name firstName=“Jimmy Floyd”
            lastName=“Hasselbaink” />
        </Player>
        <Team id=“4” name=“Chelsea”>Chelsea</Team>
        <Score normalTime=“43:26” addedTime=“0:00” home=“0”
            away=“2” />
```

| | |
|---|---|
| </Goal> | (F) |

```
    </Event>
  - <TextFeed id=“73” correction=“No” normalTime=“42:45”
      addedTime=“0:00” xml:lang=“en-GB”>
      Foul by
    - <Player id=“122”>
        <Name>Billy McKinlay</Name>
      </Player>
      <Team id=“29”>(Leicester)</Team>
      on
      - <Player id=“32973”>
        <Name>Jimmy Floyd Hasselbaink</Name>
      </Player>
      <Team id=“4”>(Chelsea)</Team>
      .
    - <Goal id=“4220210”>
        Free kick scored by
      - <Player id=“32973”>
          <Name>Jimmy Floyd Hasselbaink</Name>
        </Player>
        <Team id=“4”>(Chelsea)</Team>
        right-footed (bottom-left of goal) from left channel (25
        yards).
      - <Score home=“0” away=“2”>
          <Team id=“29”>Leicester</Team>
          0-2
        <Team id=“4”>Chelsea</Team>
        .
      </Score>
```

| | |
|---|---|
| </Goal> | (G) |
| </TextFeed> | |
| </MatchLive> | |

(A) this gives the address for the XML feed;
(B) identifies the match as Chelsea v Leicester using suppliers database;
(C) describes that a foul was committed at time 42:45 into match, on player id = 32973 - Jimmy Floyd Hasselbaink (identified from data base), of team id = 4 - Chelsea (identified from data base), by played id = 122 - Billy McKinlay (identified from data base); of team id = - Leicester (identified from data base);
(D) describes a free kick given at the time 42-48 into match, taken with right foot, from the left channel by played id = 32973 - Jimmy Floyd Hasselbaink, of team id = - Chelsea;
(F) describes that the free kick was taken at time 43:26; was a shot taken with the right foot, from the left channel at a distance of 25 yards,
(G) describes that the goal was scored by Player id = 32973 Jimmy Floyd Hasselbaink of team id = 4 Chelsea, scored left low of the goal;
(H) provides a text summary of the event.

In accordance with the present invention, the above XML feed is converted into key-frame data which enables the smart application loaded on a digital telephone device 12 to set up frames corresponding to the frames shown in FIGS. 2, 3, 5 and 9.

The data file for each key-frame, includes the following information on each of the players in the frame:
X, co-ordinate of the pitch at which the player is located;
Y, co-ordinate of the pitch at which the player is located;
Z, the height of the player off the ground;
Rotation, the angle of the player relative to the goal (X direction of the pitch) 0 representing towards the goal and 180 away from the goal;

| | |
|---|---|
| State, the action of the player, e.g. | 0 = standing |
| | 1 = running |
| | 2 = fouled |
| | 3 = slide |
| | 4 = dive right; |
| | 5 = dive left; |
| | 6 = kick; and |
| | 7 = jump. |
| Team e.g. | 0 = home team |
| | 1 = away team. |

and;
data representing the position of the ball 30 in each frame:
X, co-ordinate of the pitch in which the ball is located;
Y, co-ordinate of the pitch in which the ball is located; and
Z, height of ball.

The X and Y co-ordinates of the pitch are based on a grid, corresponding to half the pitch, on which the X co-ordinate is from 0-800 and the Y co-ordinate is from 0-600, the origin of the co-ordinates being outside the left hand corner of the pitch. Each frame of the visual display will typically cover an area X by Y of 189×208. The simulated visual display of the event will typically run at 10 to 14 frames per second, depending on the mobile telephone device 12.

For the event described above, the XML feed is converted into four “key-frames, corresponding to FIGS. 2, 3, 6 and 9. This may be done manually by an event editor. As illustrated in FIG. 13 the event editor has a screen which shows half a pitch and sprites representing the players 30 to 44 and ball 50. The sprites are moved about the screen and are assigned animation properties, for example stand, run, jump, kick etc., to set-up the key-frame, which is then converted into key-frame data code. Alternatively software may be used to convert the XML feed directly into Key-frame data code.

The data file for the frame illustrated in FIG. 2 “Key-frame 1” will typically be as follows, the comments are given on parenthesis not forming part of the data file:
Key-frame 1

| | |
|---|---|
| Player 1 | [Jimmy Floyd Hasselbank 30] |
| X = 136 | |
| Y = 190 | |
| Z = 0 | |
| Rotation = 90 | |
| State = 1 | [running] |
| Team = 0 | [home - Chelsea] |
| Player 2 | [Billy McKinlay 32] |
| X = 142 | |
| Y = 158 | |
| Z = 0 | |
| Ratation = 135 | |
| State = 1 | [running] |
| Team = 1 | [away - Leicester] |
| Ball | [50] |
| X = 142 | |
| Y = 190 | |
| Z = 0 | |

The data file for the frame illustrated in FIG. 3, “Key-frame 2” will be as follows:
Key-frame 2

| | |
|---|---|
| Player 1 | [Jimmy Floyd Hasselbank 30] |
| X = 176 | |
| Y = 190 | |
| Z = 0 | |
| Ratation = 90 | |
| State = 2 | [fouled] |
| Team = 0 | [home - Chelsea] |
| Player 2 | [Billy McKinlay 32] |
| X = 174 | |
| Y = 188 | |
| Z = 0 | |
| State = 3 | [sliding tackle] |
| Team = 1 | [away - Leicester] |
| Ball | [50] |
| X = 206 | |
| Y = 180 | |
| Z = 0 | |

For the data file for the frame illustrated in FIG. 5 “key-frame 3”, various assumptions are made, for example that the defending team will form a wall, ie. players represented by sprites 34,36 and 38 and that there will be home players ie. player represented by sprite 40 on the goal side of the free kick;
Key-frame 3

| | |
|---|---|
| Player 1 | [Jimmy Floyd Hasselbank 30] |
| X = 162 | |
| Y = 198 | |
| Z = 0 | |
| Rotation = 45 | |
| State = 0 | [standing] |
| Team = 0 | [home - Chelsea] |
| Player 2 | [defensive player 34 on the far left of the wall] |
| X = 238 | |
| Y = 127 | |
| Z = 0 | |
| Rotation = 225 | |
| State = 0 | [standing] |
| Team = 1 | [away - Leicester] |
| Player 3 | [defensive player 36 in the middle of the wall] |
| X = 247 | |
| Y = 133 | |
| Z = 0 | |
| Rotation = 225 | |
| State = 0 | [standing] |
| Team = 1 | [away - Liecester] |
| Player 4 | [defensive player 38 on the right of the wall] |
| X = 259 | |
| Y = 141 | |
| Z = 0 | |
| Rotation = 225 | |
| State = 0 | [standing] |
| Team = 1 | [away - Liecester] |
| Player 5 | [attacking player 40 on the edge of the wall of |
| | the wall] |
| X = 306 | |
| Y = 145 | |
| Z = 0 | |
| Rotation = 225 | |
| State = 0 | [standing] |
| Team = 1 | [home - Chelsea] |
| Ball | [50] |
| X = 195 | |
| Y = 178 | |
| Z = 0 | |

Finally for the frame illustrated in FIG. 9, “key-frame 4”, it is assumed that the goal keeper, represented by sprite 22 will dive in an attempt to save the ball 30 and that defending player 24 will be positioned behind the wall;
Key-frame 4

| | |
|---|---|
| Player 1 | [defensive player 34] |
| X = 237 | |
| Y = 126 | |
| Z = 0 | |
| Rotation = 225 | |
| State = 0 | [standing] |
| Team = 0 | [away - Leicester] |
| Player 2 | [defensive player 44] |
| X = 355 | |
| Y = 118 | |
| Z = 0 | |
| Rotation = 180 | |
| State = 0 | [standing] |
| Team = 0 | [away - Leicester] |
| Player 3 | [goal keeper 42] |
| X = 365 | |
| Y = 52 | |
| Z = 0 | |
| Rotation = 180 | |
| State = 4 | [dive right] |
| Team = 0 | [away - Leicester] |
| Ball | [50] |
| X = 306 | |
| Y = 40 | |
| Z = 0 | |

The above key-frame date, for key-frame 1; key-frame 2; key-frame 3 and key-frame 4, is compiled into an animation script and is sent as a text message via the SMS/MMS Centre, to any mobile telephone device which has subscribed to “Alerts” from the match.

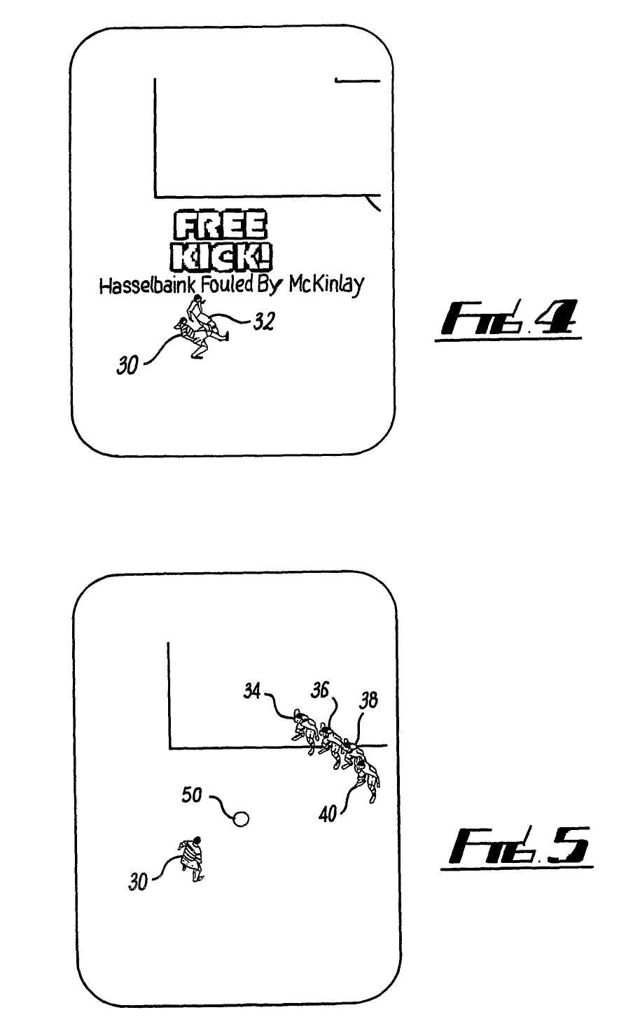

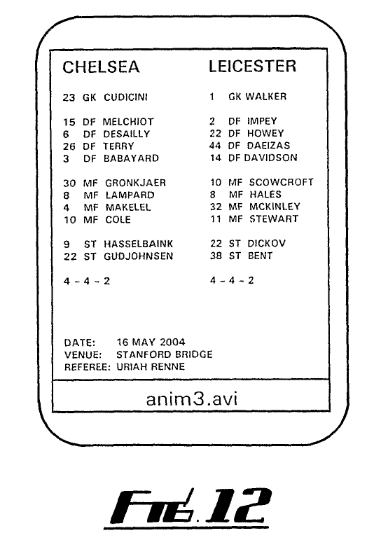

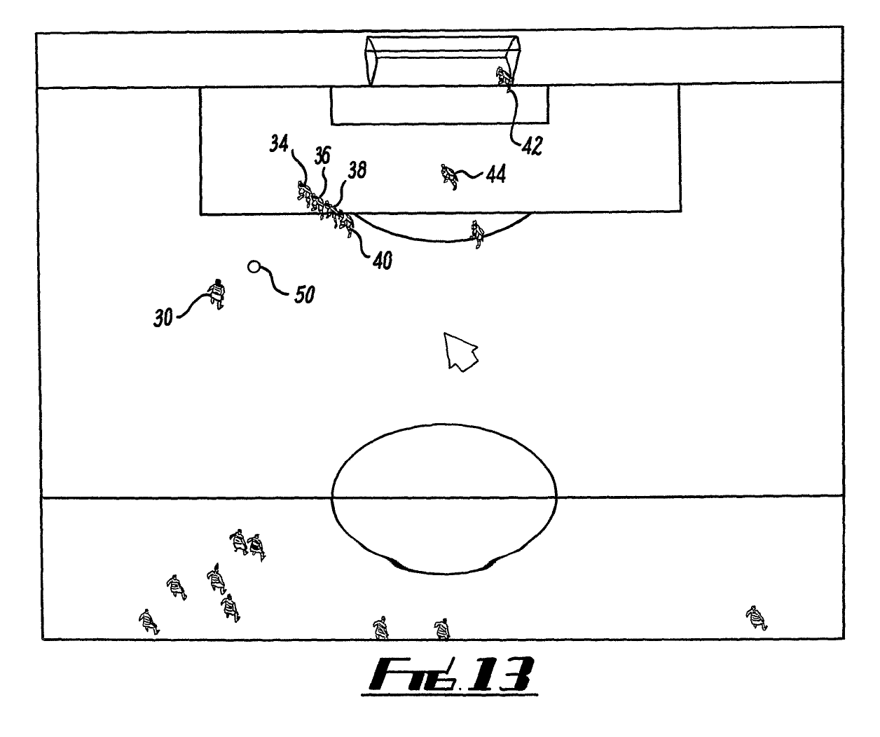

The animation script may also include text which may be superimposed on a frame of the visual display, as illustrated in FIGS. 4 and 10, to supplement the visual display, or be displayed in separate frames, for example to give the score line after the displayed event and/or give match and team details, as illustrated in FIGS. 11 and 12.

Separators may be used between key-frame data in the animation script, to differentiate between key-frames which constitute a continuous action and key-frames relating to successive but separate actions. That is, in the above example, there will be a separator between key-frame 2 (FIG. 3), where the foul is committed and key-frame 3 (FIG. 5), in which the free kick is set-up. The separator may be any suitable punctuation character, for example a comma, in the animation script. The animation script text message, which will typically be less than 5 k (kilobytes), contains sufficient information on the positions, moves and results of the action to produce approximately 12 seconds of animation.

Upon opening of the animation script text message, a smart client application loaded on the mobile telephone device 12, will automatically play the visual display simulating the event from the match.

The smart client application, which will typically be in Java or Symbian or Brew languages, includes animation properties of the pitch, team colours, individual character moves, sounds and other graphics, which are used to provide the simulated visual display of the action, from the key-frame data. The smart client application replicates the key-frames from the key-frame data, centring the frame on the position of the ball 50, and will play the key-frames in sequence. In addition, the smart client application will interpolate between key-frames, generating intermediate frames, as illustrated in FIGS. 6 to 8. The timing of the action and hence the number of intermediate frames generated by the smart client application, will be controlled by the distances moved by the players and ball, between key-frames, typically to give 1 pixel movement per frame. In addition certain actions, defined by the “state” in the key-frame data, may take place over a predetermined number of frames, for example “slide” which signifies a sliding tackle may be allotted 10 frames and “dive right” or “dive left” 15 frames.

If separators appear in the text message to indicate that the action is not continuous, for example as between key-frames 2 and 3 in the above example, then the smart client application will hold key-frame 2 for a predetermined number of frames, when the text “FREE KICK! Hasslebaink Fouled By McKinlay” may be superimposed, as illustrated in FIG. 4. Then after setting up and displaying key-frame 3 (FIG. 5) the smart client application will pause for a predetermined number of frames, before going from key-frame 3 to key-frame 4. At the end of the action the smart client application will again hold key-frame 4 (FIG. 9) for a predetermined number of frames, when the text “GOAL” may be superimposed, as illustrated in FIG. 10. The smart client application then goes on to display other text messages received with the key-frame data in the animation script, as illustrated in FIGS. 11 and 12.

The animation script may subsequently be stored on the mobile digital telephone device, so that the visual display of the event may be replayed by the subscriber.

While in the above embodiment the invention is described with reference to a mobile digital telephone network, the system maybe used with any mobile digital system, where the devices have a digital display.

1-53. (canceled)

54. A digital telephone system for providing visual displays of live events the system comprising:
a data feeder for providing a data feed of one or more real time actions which make up a live event;
a converter for converting the data feed into an animation script which controls the movement of one or more objects in a simulation of the live event;
a transmitter for transmitting the animation script to a digital telephone device; and
a digital telephone device, the digital telephone device having a visual display and being programmed with a smart client application, the smart client application including fixed background data relating to the live event, the smart client application being controlled by the animation script so that the one or more objects are moved to simulate the one or more actions of the live event.

55. A digital telephone system according to claim 54, wherein the data feed is in text format.

56. The digital telephone system according to claim 54, wherein the animation script is transmitted to the digital telephone device as a text message.

57. The digital telephone system according to claim 54, wherein the data feed is in XML format.

58. The digital telephone system according to claim 54, wherein the data feed is converted into an animation script by an event editor.

59. The digital telephone system according to claim 58, wherein the event editor is operated manually.

60. The digital telephone system according to claim 54, wherein the data feed is converted into an animation script by software.

61. The digital telephone system according to claim 54, wherein the animation script includes a plurality of key-frame data files.

62. The digital telephone system according to claim 61, wherein each key-frame data file includes data relating to one frame of action of a digital display.

63. The digital telephone system according to claim 62, wherein the data includes data relating to a position, a direction, a state and/or an identity of one or more objects.

64. The digital telephone system according to claim 61, wherein the animation script includes separators between successive key-frame data files to differentiate between key-frames which constitute a continuous action and key-frames which constitute successive but separate actions.

65. The digital telephone system according to claim 61, wherein the animation script includes text which is superimposed on frames of the visual display or, which may form frames of the visual display.

66. The digital telephone system according to claim 54, wherein the smart client application includes data relating to animation properties of at least one of a pitch, object colours, individual object moves, sounds associated with actions and other graphics.

67. The digital telephone system according to claim 54, wherein the smart client application includes software for replicating key-frames of an event, from the key-frame data files of the animation script.

68. The digital telephone system according to claim 66, wherein the smart client application includes software for interpolating between key-frames and generating intermediate frames of a visual display.

69. The digital telephone system according to claim 54, wherein the animation script is transmitted in SMS or MMS format to the digital telephone device.

70. The digital telephone system according to claim 54, wherein a dedicated download server is connected to an SMS/MMS telephone network by an internet connection; the download server comprising a subscriber database on which details of subscribers are stored and a replay module which serves to convert the data feed into an animation script; and the replay module is connected to a source of the data feed by an internet connection.

71. A method of providing a simulated visual display of a live event, comprising:
producing a data feed, in text format, describing one or more real time actions of the live event;
converting the data feed into an animation script which controls the movement of one or more objects in a simulation of the live event; and
transmitting the animation script to a smart client application, the smart client application including fixed background data relating to the live event and being controlled by the animation script, so that the one or more objects are moved about a display to simulate the actions of the live event.

72. The method according to claim 71, further comprising the step of feeding the data feed in XML format.

73. The method according to claim 71, further comprising the step of including, in the animation script, a plurality of key-frame data files.

74. The method according to claim 73, further comprising the step of including, in each key-frame data file, data relating to one frame of action of a digital display.

75. The method according to claim 74, further comprising the step of having the data include data relating to a position, a direction, a state and/or an identity of one or more objects.

76. The method according to claim 71, further comprising the step of including, in the animation script, separators between successive key-frame data files to differentiate between key-frames which constitute a continuous action and key-frames which constitute successive but separate actions.

77. The method according to claim 71, further comprising the step of including, in the animation script, text which is superimposed on frames of the visual display or, which may form frames of the visual display.

78. The method according to claim 71, further comprising the step of providing the smart client application with data relating to animation properties of the pitch, object colours, individual object moves, sounds associated with actions and other graphics.

79. The method according to claim 71, further comprising the step of replicating, in the smart client application, key-frames of an event, from the key-frame data files of the animation script.

80. The method according to claim 79, further comprising the step of interpolating, in the smart client application, between key-frames and generates intermediate frames of a visual display.

81. The method according to claim 71, further comprising the step of having, the number of frames interposed between key-frames, being dependant on the distance moved by the objects between successive key-frames.

82. The method according to claim 80, further comprising the step of having the smart client application allow a predetermined number of frames for specified actions.

83. The method according to claim 71, further comprising the step of having the smart client application pause for a predetermined duration, between key-frames in response to a separator in the animation script.

84. The method according to claim 83, further comprising the step of having the smart client application hold the display at the key-frame preceding the separator for a predetermined number of frames, before proceeding to the next key-frame and will then hold said next frame for a predetermined number of frames, before proceeding with the action.

85. A smart client application, the smart client application including fixed background data relating to a live event, the smart client application being adapted to receive an animation script, the smart client controlled by the animation script so that one or more objects are moved to simulate one or more actions of the live event.

86. The smart client application according to claim 85, wherein the animation script is in text format.

87. The smart client application according to claim 85, wherein the animation script is received in the form of a text message.

88. The smart client application according to claim 85, wherein the animation script is in XML format.

89. The smart client application according to claim 85, wherein the animation script includes a plurality of key-frame data files.

90. The smart client application according to claim 89, wherein each key-frame data file includes data relating to one frame of action of a digital display.

91. The smart client application according to claim 90, wherein the data includes, data relating to a position, a direction, a state and/or an identity of one or more objects.

92. The smart client application according to claim 89, wherein the animation script includes separators between successive key-frame data files to differentiate between key-frames which constitute a continuous action and key-frames which constitute successive but separate actions.

93. The smart client application according to claim 89, wherein the animation script includes text which may be superimposed on frames of the visual display or, which may form frames of the visual display.

94. The smart client application according to claim 89, wherein the smart client application includes data relating to animation properties of at least one of a pitch, object colours, individual object moves, sounds associated with actions and other graphics.

95. The smart client application according to claim 89, wherein the smart client application includes software for replicating key-frames of an event, from the key-frame data files of the animation script.

96. The smart client application according to claim 94, wherein the smart client application includes software for interpolating between key-frames and generating intermediate frames of a visual display.

97. The smart client application according to claim 89, wherein the animation script is transmitted in SMS or MMS format to the smart client application.

98. The smart client application according to claim 89, adapted to communicate with a dedicated download server, the dedicated download server connected to an SMS/MMS telephone network by an internet connection; the download server comprising a subscriber database on which details of subscribers are stored and a replay module which serves to convert a data feed into an animation script; the replay module being connected to a source of the data feed by an internet connection.

99. At least one computer program comprising program instructions, which, when loaded into at least one computer, operates the digital telephone system as defined by claim 54.

100. At least one computer program comprising program instructions, which, when loaded into at least one computer, comprises the smart client application as defined by claim 89.

101. At least one computer program comprising program instructions, which, when loaded into at least one digital telephone device, comprises the smart client application as defined by claim 89.

102. At least one computer program comprising program instructions, which, when loaded into at least one computer, cause the at least one computer to perform the method of claim 71.

103. The computer programs as defined by claim 100, wherein the computer programs are embodied on a recording medium or read-only memory, stored in at least one computer memory, or carried on an electrical carrier signal.
